(19) United States
(12) Patent Application Publication
(10) Pub. No.: US 2014/0077712 A1
(43) Pub. Date: Mar. 20, 2014

(54) LED DRIVING APPARATUS AND OPERATING METHOD THEREOF

(71) Applicant: Raydium Semiconductor Corporation, Hsinchu (TW)

(72) Inventors: Chung-Tai Cheng, Zhubei City (TW); Chia-Hsiu Lin, Hsinchu City (TW)

(73) Assignee: Raydium Semiconductor Corporation, Hsinchu (TW)

(21) Appl. No.: 14/030,640

(22) Filed: Sep. 18, 2013

(30) Foreign Application Priority Data
Sep. 18, 2012 (TW) 101134160

(51) Int. Cl. H05B 33/08

(52) U.S. Cl. CPC H05B 33/0824
USPC 315/193

(57) ABSTRACT

A LED driving apparatus and an operating method thereof are disclosed. The LED driving apparatus includes a controller and an output stage. The output stage includes at least one LED, a switch, and a setup resistor. The at least one LED, the switch, and the setting resistor are coupled in series between an input voltage and ground. The controller is coupled to the input voltage and the switch respectively. The controller receives at least one voltage sensing signal and outputs a setup voltage signal to the output stage. The at least one voltage sensing signal is received from the node between the at least one LED and the switch, between two LEDs, or between two voltage dividing resistors coupled in series between the input voltage and ground.

### CROSS-REFERENCE TO RELATED APPLICATIONS

This non-provisional application claims priority under 35 U.S.C. §119(a) on Patent Application No(s). 101134160 filed in Taiwan, R.O.C. on Sep. 18, 2012, the entire contents of which are hereby incorporated by reference.

### BACKGROUND OF THE INVENTION

1. Field of the invention

The invention relates to the driving of a light-emitting diode (LED); in particular, to a LED driving apparatus and operating method thereof.

2. Description of the prior art

In general, the operation theorem of the conventional AC to DC type of LED driving circuit is to use an AC to DC converter to generate the input voltage needed to conduct upper side of the LED to drive the LED to emit lights, and simultaneously disposes a current source circuit at lower side of the LED to control the fixed current flowing through the LED to the ground terminal, and the brightness of the LED can be stabilized. Since the input voltage is a rectified signal instead of DC voltage, the LED driving circuit is necessary to drive the LED to achieve better power factor (PF) and luminous efficiency.

However, the setting voltage outputted from the setting voltage generator to the current source circuit at lower side of the LED is changed with the input voltage in the prior art; therefore, as shown in the wave-form diagrams of its input voltage, LED current, and power consumption of FIG. 1A˜FIG. 1C, the LED current (I_{LED}) is changed with different input voltages. When the input voltage becomes larger, the LED current (I_{LED}) also becomes larger; therefore, it will cause the problem of inaccurate LED current at different input voltages (high input voltage VH and low input voltage VL), namely the problem of poor input voltage line regulation. In addition, because both the voltage and current of the current source circuit disposed at the lower side of the LED become larger, the power consumption will also become larger to cause the overheat problem.

Therefore, the invention provides a LED driving apparatus and operating method thereof to solve the above-mentioned problems occurred in the prior arts.

### SUMMARY OF THE INVENTION

An embodiment of the invention is a LED driving apparatus. In this embodiment, the LED driving apparatus includes an output stage and at least one controller. The output stage includes at least one LED, a switch, and a setting resistor. The at least one LED is coupled to an input voltage. The switch is coupled to the at least one LED. The setting resistor is coupled between the switch and a ground terminal The at least one controller is coupled to the input voltage and the switch respectively and used for receiving at least one voltage sensing signal and outputting a setting voltage signal to the switch.

In an embodiment, the at least one LED includes a first LED, a second Led, and a third LED. The LED driving apparatus further includes a first resistor, a first switch, a second resistor, and a second switch. The first resistor is coupled to the ground terminal. The first switch is coupled to a node between the first LED and the second LED, the first resistor, and the at least one controller respectively. The second resistor is coupled to the ground terminal The second switch is coupled to another node between the second LED and the third LED, the second resistor, and the at least one controller respectively.

In an embodiment, the controller is coupled between the second LED and the third LED to receive a first voltage sensing signal and coupled between the third LED and the switch to receive a second voltage sensing signal.

In an embodiment, the LED driving apparatus further includes a plurality of voltage dividing resistors coupled in series between the input voltage and the ground terminal. The plurality of voltage dividing resistors includes a first dividing resistor, a second dividing resistor, and a third dividing resistor. The controller is coupled between the first dividing resistor and the second dividing resistor to receive a first voltage sensing signal and coupled between the second dividing resistor and the third dividing resistor to receive a second voltage sensing signal.

In an embodiment, the controller receives the voltage sensing signal from the LED and the switch.

In an embodiment, the at least one controller includes a first controller, a second controller, and a third controller. The first controller is coupled between the first LED and the second LED to receive a first voltage sensing signal and coupled to the first switch. The second controller is coupled between the second LED and the third LED to receive a second voltage sensing signal and coupled to the second switch. The second controller is coupled between the second LED and the third LED to receive a second voltage sensing signal and coupled to the second switch.

Another embodiment of the invention is a LED driving apparatus operating method. In this embodiment, the LED driving apparatus operating method is used to operate a LED driving apparatus including an output stage and at least one controller. The output stage includes at least one LED, a switch, and a setting resistor. The at least one LED is coupled to an input voltage. The switch is coupled to the at least one LED. The setting resistor is coupled between the switch and a ground terminal. The at least one controller is coupled to the input voltage and the switch respectively. The method includes steps of: (a) using the controller to receive at least one voltage sensing signal; and (b) using the controller to output a setting voltage signal to the switch according to the at least one voltage sensing signal.

Compared to the prior art, the LED driving apparatus and operating method thereof can achieve the effects of: (1) effectively avoiding the excessive power consumption problem and overheat problem when the input voltage is excessive; (2) effectively avoiding the problem of inaccurate LED current at different input voltages, namely the problem of poor input voltage line regulation; (3) using a splicing method to increase the power factor.

The advantage and spirit of the invention may be understood by the following detailed descriptions together with the appended drawings.

### BRIEF DESCRIPTION OF THE APPENDED DRAWINGS

FIG. 1A˜FIG. 1C illustrate wave-form diagrams of input voltage, LED current, and power consumption of the LED driving apparatus in prior art respectively.

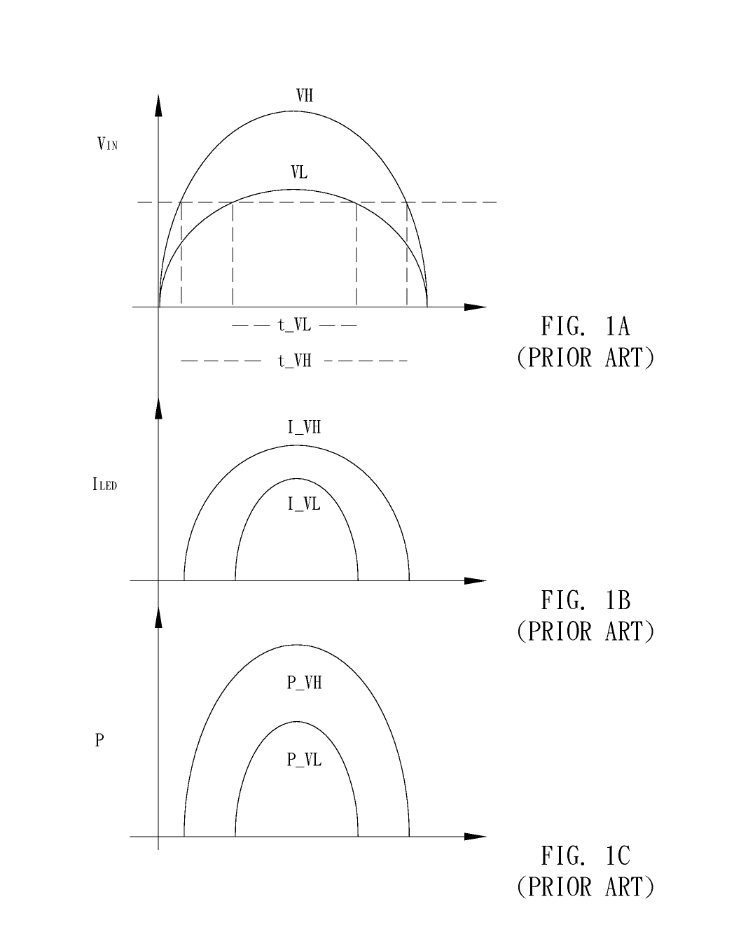

FIG. 2 illustrates a schematic diagram of the circuit structure of the LED driving apparatus in an embodiment of the invention.

FIG. 3A˜FIG. 3C illustrate wave-form diagrams of input voltage, LED current, and power consumption of the LED driving apparatus in FIG. 2 respectively.

FIG. 4 illustrates a schematic diagram of the circuit structure of the LED driving apparatus in another embodiment of the invention.

FIG. 5 illustrates a schematic diagram of the circuit structure of the LED driving apparatus in another embodiment of the invention.

FIG. 6 illustrates a schematic diagram of the circuit structure of the LED driving apparatus in another embodiment of the invention.

FIG. 7 illustrates a flow chart of the LED driving apparatus operating method in another embodiment of the invention.

### DETAILED DESCRIPTION OF THE INVENTION

An embodiment of the invention is a LED driving apparatus. In this embodiment, the LED driving apparatus is used to drive the LED to emit lights, but not limited to this.

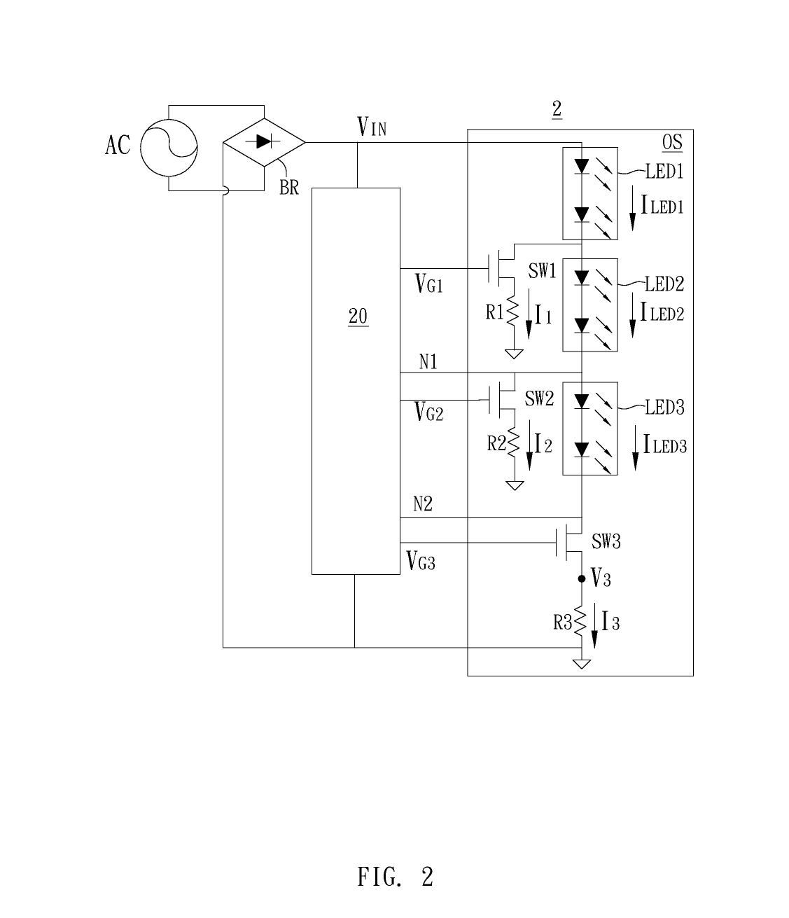

Please refer to FIG. 2. FIG. 2 illustrates a schematic diagram of the circuit structure of the LED driving apparatus in this embodiment. As shown in FIG. 2, the LED driving apparatus 2 includes a controller 20, an output stage OS, an AC power source AC, and a bridge rectifier BR. The AC power source AC is coupled to the bridge rectifier BR; the bridge rectifier BR is coupled to a ground terminal, the controller 20, and the output stage OS; the controller 20 is coupled between an input voltage V_{IN} and the ground terminal and coupled to the output stage OS. In fact, the controller 20 can be a subtractor or a proportional integrator, but not limited to this.

The output stage OS includes light-emitting diode strings LED1˜LED3 coupled in series, resistor units R1˜R2, a setting resistor unit R3, and transistor units SW1˜SW3. One end of the setting resistor unit R3 is coupled to the ground terminal, another end of the setting resistor unit R3 is coupled to the transistor unit SW3. The transistor unit SW3 is coupled between the light-emitting diode string LED3 and the setting resistor unit R3. The light-emitting diode strings LED1˜LED3 are coupled between the input voltage V_{IN} and the transistor unit SW3.

A gate electrode of the transistor unit SW1 is coupled to the controller 20, and a source electrode and a drain electrode of the transistor unit SW1 are coupled to a node between the light-emitting diode strings LED1 and LED2 and the resistor unit R1. The resistor unit R1 is coupled between the transistor unit SW1 and the ground terminal.

Similarly, a gate electrode of the transistor unit SW2 is coupled to the controller 20, and a source electrode and a drain electrode of the transistor unit SW2 are coupled to a node between the light-emitting diode strings LED2 and LED3 and the resistor unit R2. The resistor unit R2 is coupled between the transistor unit SW2 and the ground terminal A gate electrode of the transistor unit SW3 is coupled to the controller 20, and a source electrode and a drain electrode of the transistor unit SW3 are coupled to light-emitting diode string LED3 and the setting resistor unit R3 respectively.

In the output stage OS, LED currents I_{LED1}˜I_{LED3} flowing through the light-emitting diode strings LED1˜LED3 respectively can be generated by a current source, and the lightness of the emitting diode strings LED1˜LED3 can be controlled by the stable LED currents I_{LED1}˜I_{LED3}. As to a setting current I₃ flowing through the setting resistor unit R3, when the transistor unit SW3 is operated in the saturation region, the current value of the setting current I₃ is equal to the voltage value of a reference voltage signal V₃ divided by the resistance of the setting resistor unit R3. In fact, the drain electrode of the transistor unit SW3 can add a high-voltage MOSFET as a switch, but not limited to this.

The controller 20 is coupled between the LED strings LED2 and LED3 to receive a first sensing voltage signal N1 and coupled between the LED string LED3 and the transistor unit SW3 to receive a second sensing voltage signal N2. The controller 20 will generate a first setting voltage signal V_{G1}, a second setting voltage signal V_{G2}, and a third setting voltage signal V_{G3} to the transistor units SW1˜SW3 according to the first sensing voltage signal N1 and the second sensing voltage signal N2 respectively to use the first setting voltage signal V_{G1}, the second setting voltage signal V_{G2}, and the third setting voltage signal V_{G3} to control the transistor units SW1˜SW3 on or off respectively.

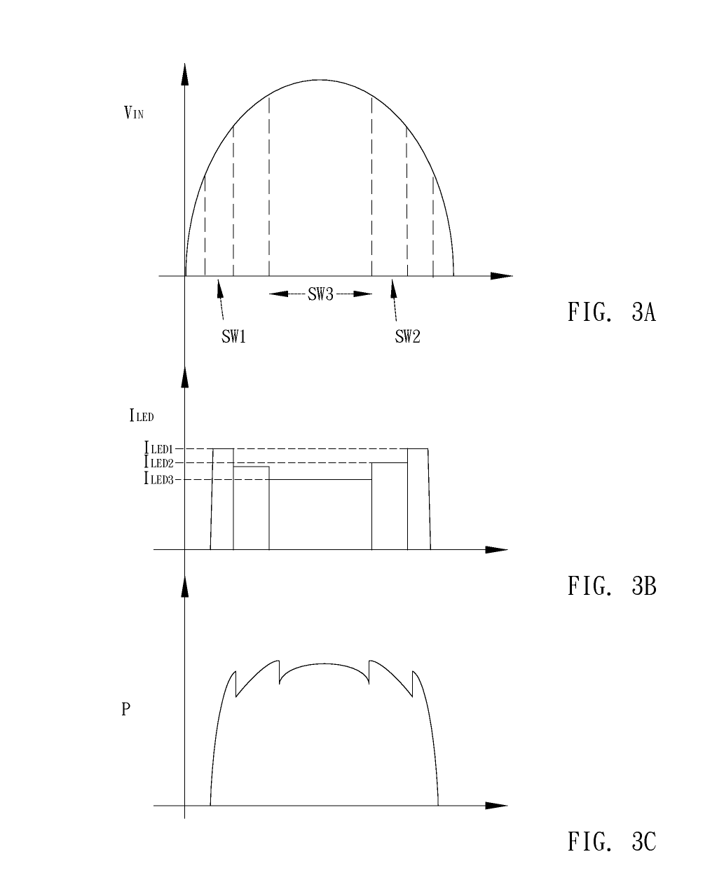

Please refer to FIG. 3A˜FIG. 3C. FIG. 3A˜FIG. 3C illustrate wave-form diagrams of the input voltage V_{IN}, the LED current I_{LED}, and the power consumption P of the LED driving apparatus 2 in FIG. 2 respectively. As shown in FIG. 3B, when the input voltage V_{IN} becomes larger, the current value of the LED current will changed from a larger I_{LED1} to a smaller I_{LED3}. Therefore, as shown in FIG. 3C, when the input voltage V_{IN} becomes larger, since the current value of the LED current I_{LED} becomes smaller, the power consumption P of the LED driving apparatus 2 will be decreased instead of being increased. Therefore, the excessive power consumption problem and overheat problem can be effectively avoided.

Another embodiment of the invention is a LED driving apparatus. In this embodiment, the LED driving apparatus is used to drive the LED to emit lights, but not limited to this.

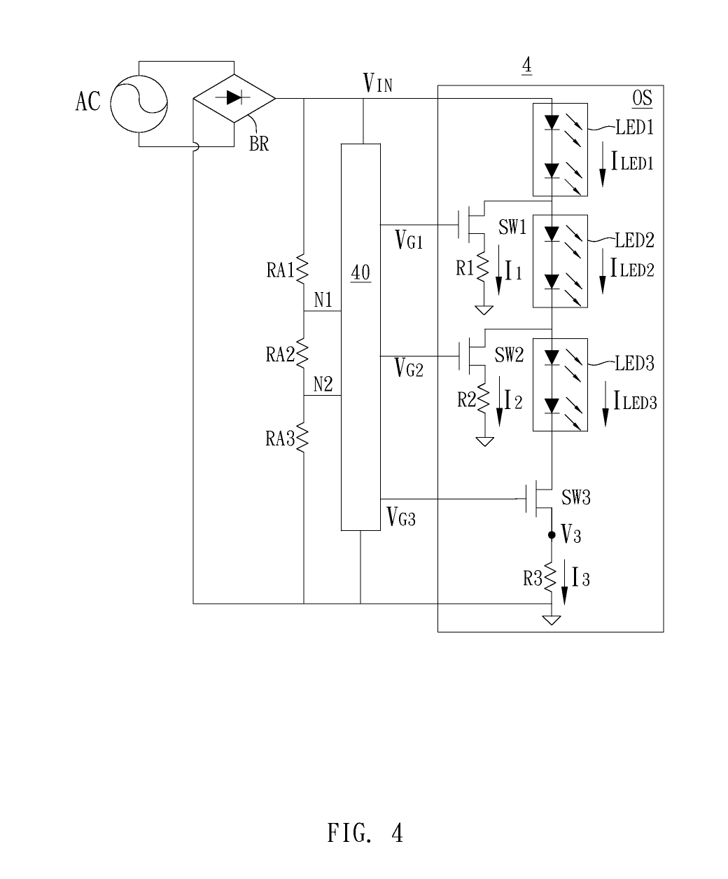

Please refer to FIG. 4. FIG. 4 illustrates a schematic diagram of the circuit structure of the LED driving apparatus in this embodiment. As shown in FIG. 4, the LED driving apparatus 4 includes a controller 40, an output stage OS, voltage dividing resistors RA1˜RA3, an AC power source AC, and a bridge rectifier BR. The AC power source AC is coupled to the bridge rectifier BR; the bridge rectifier BR is coupled to a ground terminal, the controller 40, and the output stage OS; the controller 40 is coupled between an input voltage V_{IN} and the ground terminal and coupled to the input voltage V_{IN}; the voltage dividing resistors RA1˜RA3 are coupled between the input voltage V_{IN} and the ground terminal. In fact, the controller 40 can be a subtractor or a proportional integrator, but not limited to this.

The output stage OS includes light-emitting diode strings LED1˜LED3 coupled in series, resistor units R1˜R2, a setting resistor unit R3, and transistor units SW1˜SW3. One end of the setting resistor unit R3 is coupled to the ground terminal, another end of the setting resistor unit R3 is coupled to the transistor unit SW3. The transistor unit SW3 is coupled between the light-emitting diode string LED3 and the setting resistor unit R3. The light-emitting diode strings LED1˜LED3 are coupled between the input voltage V_{IN} and the transistor unit SW3.

A gate electrode of the transistor unit SW1 is coupled to the controller 40, and a source electrode and a drain electrode of the transistor unit SW1 are coupled to a node between the light-emitting diode strings LED1 and LED2 and the resistor unit R1. The resistor unit R1 is coupled between the transistor unit SW1 and the ground terminal.

Similarly, a gate electrode of the transistor unit SW2 is coupled to the controller 40, and a source electrode and a drain electrode of the transistor unit SW2 are coupled to a node between the light-emitting diode strings LED2 and LED3 and the resistor unit R2. The resistor unit R2 is coupled between the transistor unit SW2 and the ground terminal A gate electrode of the transistor unit SW3 is coupled to the controller 40, and a source electrode and a drain electrode of the transistor unit SW3 are coupled to light-emitting diode string LED3 and the setting resistor unit R3 respectively.

In the output stage OS, LED currents I_{LED1}˜I_{LED3} flowing through the light-emitting diode strings LED1˜LED3 respectively can be generated by a current source, and the lightness of the emitting diode strings LED1˜LED3 can be controlled by the stable LED currents I_{LED1}˜I_{LED3}. As to a setting current I₃ flowing through the setting resistor unit R3, when the transistor unit SW3 is operated in the saturation region, the current value of the setting current I₃ is equal to the voltage value of a reference voltage signal V₃ divided by the resistance of the setting resistor unit R3. In fact, the drain electrode of the transistor unit SW3 can add a high-voltage MOSFET as a switch, but not limited to this.

The controller 40 is coupled between the voltage dividing resistors RA1 and RA2 to receive a first sensing voltage signal N1 and coupled between the voltage dividing resistors RA2 and RA3 to receive a second sensing voltage signal N2. The controller 40 will generate a first setting voltage signal V_{G1} a second setting voltage signal V_{G2}, and a third setting voltage signal V_{G3} to the transistor units SW1˜SW3 according to the first sensing voltage signal N1 and the second sensing voltage signal N2 respectively to use the first setting voltage signal V_{G1}, the second setting voltage signal V_{G2}, and the third setting voltage signal V_{G3} to control the transistor units SW1˜SW3 on or off respectively.

The wave-form diagrams of the input voltage V_{IN}, the LED current I_{LED}, and the power consumption P of the LED driving apparatus 4 in FIG. 4 are also shown in FIG. 3A˜FIG. 3C respectively.

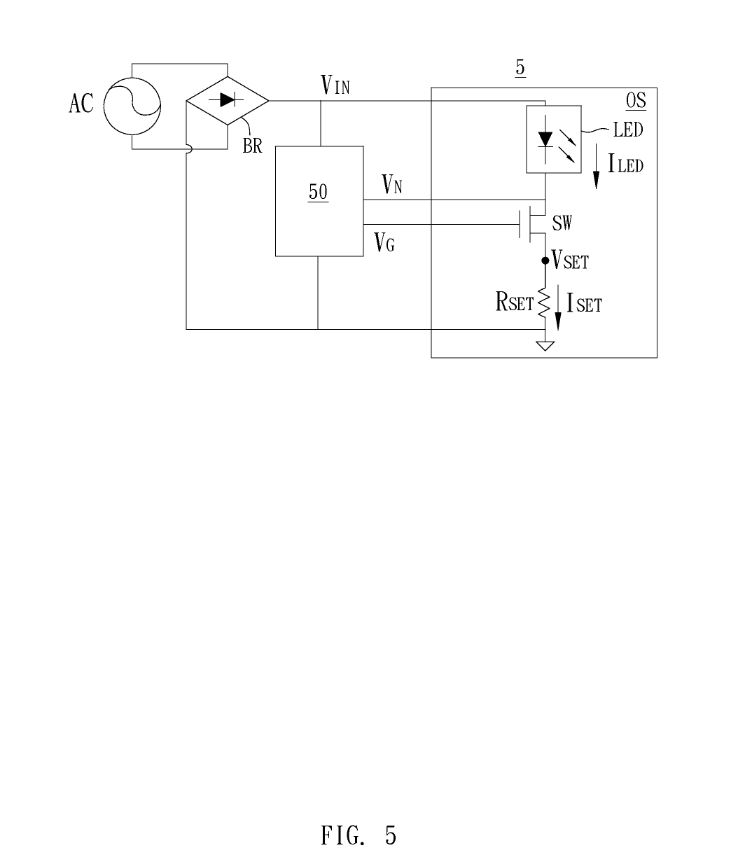

Please refer to FIG. 5. FIG. 5 illustrates a schematic diagram of the circuit structure of the LED driving apparatus in this embodiment. As shown in FIG. 5, the LED driving apparatus 5 includes a controller 50, an output stage OS, an AC power source AC, and a bridge rectifier BR. The AC power source AC is coupled to the bridge rectifier BR; the bridge rectifier BR is coupled to a ground terminal, the controller 50, and the output stage OS; the controller 50 is coupled between an input voltage V_{IN} and the ground terminal and coupled to the output stage OS. In fact, the controller 50 can be a subtractor or a proportional integrator, but not limited to this.

The output stage OS includes a light-emitting diode string LED, a setting resistor unit R_{SET}, and a transistor unit SW. One end of the setting resistor unit R_{SET} is coupled to the ground terminal, another end of the setting resistor unit R_{SET} is coupled to the transistor unit SW. The transistor unit SW is coupled between the light-emitting diode string LED and the setting resistor unit R_{SET}. The light-emitting diode string LED is coupled between the input voltage V_{IN} and the transistor unit SW. A gate electrode of the transistor unit SW is coupled to the controller 50, and a source electrode and a drain electrode of the transistor unit SW are coupled to the light-emitting diode string LED and the setting resistor unit R_{SET} respectively.

In the output stage OS, a LED current I_{LED} flowing through the light-emitting diode string LED can be generated by a current source, and the lightness of the emitting diode string LED can be controlled by the stable LED current I_{LED}. As to a setting current I_{SET} flowing through the setting resistor unit R_{SET}, when the transistor unit SW is operated in the saturation region, the current value of the setting current I_{SET} is equal to the voltage value of a reference voltage signal V_{SET} divided by the resistance of the setting resistor unit R_{SET}. In fact, the drain electrode of the transistor unit SW can add a high-voltage MOSFET as a switch, but not limited to this.

The controller 50 is coupled between the light-emitting diode string LED and transistor unit SW to receive a sensing voltage signal V_{N}. The controller 50 will generate a setting voltage signal V_{G} to the transistor unit SW according to the sensing voltage signal V_{N} to use the setting voltage signal V_{G} to control the transistor unit SW on or off respectively.

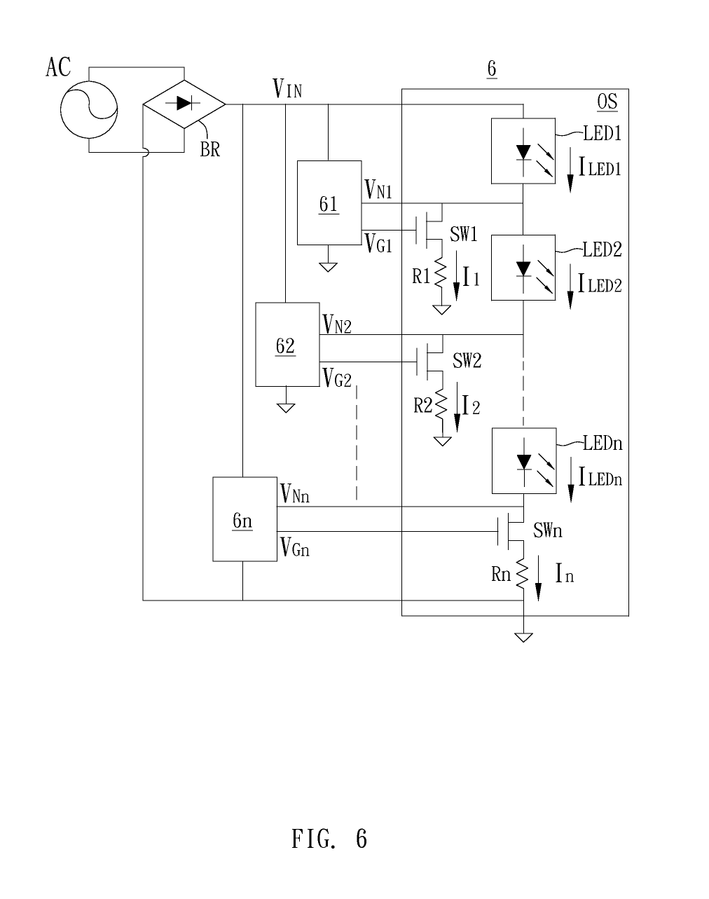

Please refer to FIG. 6. FIG. 6 illustrates a schematic diagram of the circuit structure of the LED driving apparatus in another embodiment. Different from the output stage OS of FIG. 5 only including one light-emitting diode string LED, the output stage OS of FIG. 6 includes n light-emitting diode strings LED1˜LEDn, wherein n is a positive integer.

As shown in FIG. 6, the LED driving apparatus 6 includes n controllers 61˜6n, an output stage OS, an AC power source AC, and a bridge rectifier BR. The AC power source AC is coupled to the bridge rectifier BR; the bridge rectifier BR is coupled to a ground terminal, the n controllers 61˜6n, and the output stage OS; the n controllers 61˜6n are coupled between an input voltage V_{IN} and the ground terminal and coupled to the output stage OS; the output stage OS is coupled between the input voltage V_{IN} and the ground terminal and coupled to the n controllers 61˜6n respectively. In fact, the n controllers 61˜6n can be subtractors or proportional integrators, but not limited to this.

The output stage OS includes n light-emitting diode strings LED1˜LEDn coupled in series, n resistor units R1˜Rn, and n transistor units SW1˜SWn. One end of the resistor unit R1 is coupled to the ground terminal, another end of the resistor unit R1 is coupled to the transistor unit SW1; one end of the resistor unit R2 is coupled to the ground terminal, another end of the resistor unit R2 is coupled to the transistor unit SW2; . . . ; one end of the resistor unit Rn is coupled to the ground terminal, another end of the resistor unit Rn is coupled to the transistor unit SWn. Currents flowing through the n resistor units R1—Rn respectively are I₁˜Iₙ.

A gate electrode of the transistor unit SW1 is coupled to the controller 61, and a source electrode and a drain electrode of the transistor unit SW1 are coupled to a node between the light-emitting diode strings LED1 and LED2 and the resistor unit R1; a gate electrode of the transistor unit SW2 is coupled to the controller 62, and a source electrode and a drain electrode of the transistor unit SW2 are coupled to a node between the light-emitting diode strings LED2 and LED3 and the resistor unit R2; . . . ; a gate electrode of the transistor unit SWn is coupled to the controller 6n, and a source electrode and a drain electrode of the transistor unit SWn are coupled to the light-emitting diode string LEDn and the resistor unit Rn.

In the output stage OS, LED currents I_{LED1}˜I_{LEDn} flowing through the light-emitting diode strings LED1˜LEDn respectively can be generated by a current source, and the lightness of the emitting diode strings LED1˜LEDn can be controlled by the stable LED currents I_{LED1}˜I_{LEDn}.

The controller 61 is coupled between the light-emitting diode strings LED1 and LED2 to receive a first sensing voltage signal V_{N1}. The controller 61 will generate a first setting voltage signal V_{G1} to the transistor unit SW1 according to the first sensing voltage signal V_{N1} to use the first setting voltage signal V_{G1} to control the transistor unit SW1 on or off respectively.

Similarly, the controller 62 is coupled between the light-emitting diode strings LED2 and LED3 to receive a second sensing voltage signal V_{N2}. The controller 62 will generate a second setting voltage signal V_{G2} to the transistor unit SW2 according to the second sensing voltage signal V_{N2} to use the second setting voltage signal V_{G2} to control the transistor unit SW2 on or off respectively.

The controller 6n is coupled between the light-emitting diode string LEDn and the transistor unit SWn to receive an nth sensing voltage signal V_{Nn}. The controller 6n will generate an nth setting voltage signal V_{Gn} to the transistor unit SWn according to the nth sensing voltage signal V_{Nn} to use the nth setting voltage signal V_{Gn} to control the transistor unit SWn on or off respectively.

Another embodiment of the invention is a LED driving apparatus operating method. In this embodiment, the LED driving apparatus operating method is used to operate a LED driving apparatus including an output stage and at least one controller. The output stage includes at least one LED, a switch, and a setting resistor. The at least one LED is coupled to an input voltage. The switch is coupled to the at least one LED. The setting resistor is coupled between the switch and a ground terminal. The at least one controller is coupled to the input voltage and the switch respectively.

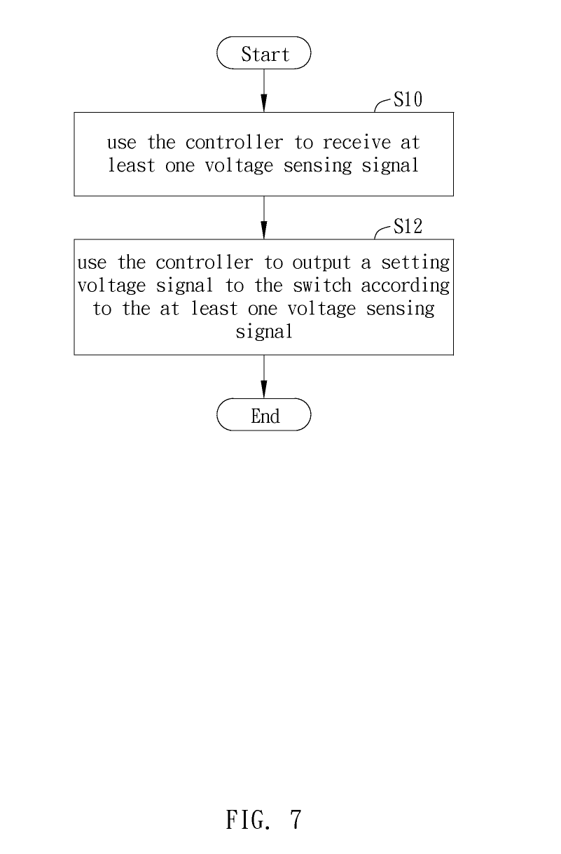

Please refer to FIG. 7. FIG. 7 illustrates a flow chart of the LED driving apparatus operating method in this embodiment. As shown in FIG. 7, at first, the method performs the step S10 to use the controller to receive at least one voltage sensing signal. Then, the method performs the step S12 to use the controller to output a setting voltage signal to the switch according to the at least one voltage sensing signal.

In an embodiment, if the at least one LED includes a first LED, a second Led, and a third LED, in the step S10, the method will use the controller to receive a first voltage sensing signal between the second LED and the third LED and receive a second voltage sensing signal between the third LED and the switch.

In another embodiment, if the LED driving apparatus further includes a plurality of voltage dividing resistors coupled in series between the input voltage and the ground terminal, the plurality of voltage dividing resistors includes a first dividing resistor, a second dividing resistor, and a third dividing resistor, in the step S10, the method will use the controller to receive a first voltage sensing signal between the first dividing resistor and the second dividing resistor and receive a second voltage sensing signal between the second dividing resistor and the third dividing resistor.

In another embodiment, in the step S10, the controller receives the voltage sensing signal between the LED and the switch.

In another embodiment, the at least one LED includes a first LED, a second LED, and a third LED. The at least one controller includes a first controller, a second controller, and a third controller. The first controller is coupled between the first LED and the second LED. The second controller is coupled between the second LED and the third LED. The third controller is coupled between the third LED and the switch. In the step S10, the method uses the first controller to receive a first voltage sensing signal between the first LED and the second LED; the method uses the second controller to receive a second voltage sensing signal between the second LED and the third LED; the method uses the controller to receive a second voltage sensing signal between the third LED and the switch.

Compared to the prior art, the LED driving apparatus and operating method thereof can achieve the effects of: (1) effectively avoiding the excessive power consumption problem and overheat problem when the input voltage is excessive; (2) effectively avoiding the problem of inaccurate LED current at different input voltages, namely the problem of poor input voltage line regulation; (3) using a splicing method to increase the power factor.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A LED driving apparatus, comprising:
an output stage, comprising:
at least one LED, coupled to an input voltage;
a switch, coupled to the at least one LED; and
a setting resistor, coupled between the switch and a ground terminal; and
at least one controller, coupled to the input voltage and the switch respectively, for receiving at least one voltage sensing signal and outputting a setting voltage signal to the switch.

2. The LED driving apparatus of claim 1, wherein the at least one LED comprises a first LED, a second Led, and a third LED, the LED driving apparatus further comprises:
a first resistor, coupled to the ground terminal;
a first switch, coupled to a node between the first LED and the second LED, the first resistor, and the at least one controller respectively;
a second resistor, coupled to the ground terminal; and
a second switch, coupled to another node between the second LED and the third LED, the second resistor, and the at least one controller respectively.

3. The LED driving apparatus of claim 2, wherein the controller is coupled between the second LED and the third LED to receive a first voltage sensing signal and coupled between the third LED and the switch to receive a second voltage sensing signal.

4. The LED driving apparatus of claim 2, further comprising:
a plurality of voltage dividing resistors, coupled in series between the input voltage and the ground terminal, comprising a first dividing resistor, a second dividing resistor, and a third dividing resistor;
wherein, the controller is coupled between the first dividing resistor and the second dividing resistor to receive a first voltage sensing signal and coupled between the second dividing resistor and the third dividing resistor to receive a second voltage sensing signal.

5. The LED driving apparatus of claim 1, wherein the controller receives the voltage sensing signal from the LED and the switch.

6. The LED driving apparatus of claim 2, wherein the at least one controller comprises:
a first controller, coupled between the first LED and the second LED to receive a first voltage sensing signal and coupled to the first switch;
a second controller, coupled between the second LED and the third LED to receive a second voltage sensing signal and coupled to the second switch; and
a third controller, coupled between the third LED and the switch to receive a third voltage sensing signal and coupled to the switch.

7. A method of operating a LED driving apparatus, the LED driving apparatus comprising an output stage and at least one controller, the output stage comprising at least one LED, a switch, and a setting resistor, the at least one LED coupling to an input voltage, the switch coupling to the at least one LED, the setting resistor coupling between the switch and a ground terminal, the at least one controller coupling to the input voltage and the switch respectively, the method comprising steps of:
(a) using the controller to receive at least one voltage sensing signal; and
(b) using the controller to output a setting voltage signal to the switch according to the at least one voltage sensing signal.

8. The method of claim 7, wherein the at least one LED comprises a first LED, a second Led, and a third LED, the step (a) comprises steps of:
(a1) using the controller to receive a first voltage sensing signal between the second LED and the third LED; and
(a2) using the controller to receive a second voltage sensing signal between the third LED and the switch.

9. The method of claim 7, wherein the LED driving apparatus further comprises a plurality of voltage dividing resistors coupled in series between the input voltage and the ground terminal, the plurality of voltage dividing resistors comprising a first dividing resistor, a second dividing resistor, and a third dividing resistor, the step (a) comprises steps of:
(a1) using the controller to receive a first voltage sensing signal between the first dividing resistor and the second dividing resistor; and
(a2) using the controller to receive a second voltage sensing signal between the second dividing resistor and the third dividing resistor.

10. The method of claim 7, wherein in the step (a), the controller receives the voltage sensing signal between the LED and the switch.

11. The method of claim 7, wherein the at least one LED comprises a first LED, a second LED, and a third LED, the at least one controller comprises a first controller, a second controller, and a third controller, the first controller is coupled between the first LED and the second LED, the second controller is coupled between the second LED and the third LED, the third controller is coupled between the third LED and the switch, the step (a) comprises the steps of:
(a1) using the first controller to receive a first voltage sensing signal between the first LED and the second LED;
(a2) using the second controller to receive a second voltage sensing signal between the second LED and the third LED; and
(a3) using the third controller to receive a third voltage sensing signal between the third LED and the switch.
